(19) United States
(12) Patent Application Publication
(10) Pub. No.: US 2026/0070508 A1
(43) Pub. Date: Mar. 12, 2026

(54) SYSTEMS AND METHODS FOR COLLECTING AND ANALYZING CONNECTED CHILD SAFETY SEAT DATA

(71) Applicant: State Farm Mutual Automobile Insurance Company, Bloomington, IL (US)

(72) Inventors: Seth CORIN, Cumming, GA (US); Jordan MENENDEZ, Bloomington, IL (US)

(73) Assignee: State Farm Mutual Automobile Insurance Company, Bloomington, IL (US)

(21) Appl. No.: 18/972,231

(22) Filed: Dec. 6, 2024

Related U.S. Application Data
(60) Provisional application No. 63/691,633, filed on Sep. 6, 2024.

(51) Int. Cl. B60R 22/48

(52) U.S. Cl. CPC B60R 22/48; B60R 2022/4808; B60R 2022/4866

(57) ABSTRACT

Various embodiments of this disclosure relate generally to analyzing a child safety seat to determine adequate installation, selection, and/or condition of the child safety seat for a child. The method comprises: (1) receiving, by one or more processors, baseline data from one or more data stores, wherein the baseline data include child safety seat data, vehicle data, and/or child biometric data; (2) receiving dynamics data from a plurality of sensors, wherein at least one of the plurality of sensors is coupled to a child safety seat; (3) inputting the baseline data and the dynamic data into a machine-learning model; (4) in response to the inputting, receiving a recommended adjustment from the machine-learning model; and/or (5) generating an alert including the recommended adjustment, and outputting the alert via a user interface of a mobile device.

### CROSS-REFERENCE TO RELATED APPLICATIONS

This patent application claims the benefit of priority to U.S. Provisional Application No. 63/691,633, filed on September 6, 2024, the entirety of which is incorporated herein by reference.

### TECHNICAL FIELD

Various embodiments of this disclosure relate generally to systems and methods for using a machine-learning model to analyze child safety seat data, and, more specifically, for generating a customized output (e.g., video output, text-based output, and/or audio output) based upon baseline and dynamic data of the child safety seat.

### BACKGROUND

Drivers may desire to have the correct installation and selection of child safety seats while transporting children. The use of the appropriate child safety seat may be imperative to the safety and comfort of children in vehicles. However, guidelines and standards for child safety seats may be constantly updated based upon new safety and health information, even though a single child safety seat may be used for years at a time. Additionally, adults may not be aware of the specifications and limitations of the child safety seats that are installed or used in their vehicles, especially with rapidly growing children.

The rapidly changing information and growth of children may mean that children are upgraded to new child safety seats too early or too late for their size. The adult users may also be unaware of expiration dates for the child safety seats. Further, defects in child safety seats may not be easily recognizable. As a result, there is a need for improvements in child safety seat analysis, installation, and selection that incorporate updated guidelines and standards for child safety seat use. These improvements may increase safety for children in vehicles, especially in the event an accident occurs when it is critical that the child is in an appropriately sized and maintained child safety seat.

Thus, there is a need to address the above-referenced challenges. Conventional techniques may include additional ineffectiveness, encumbrances, inefficiencies, and drawbacks as well.

### SUMMARY

The present embodiments may relate, inter alia, solving one or more technical challenge, such as those discussed above and elsewhere herein. Specifically, the present computers systems and computer-implemented methods may solve technical challenges by generating a customized output (e.g., video output, text-based output, and/or audio output) based upon baseline and dynamic data of the child safety seat.

In one aspect, a computer-implemented method for analyzing child safety seat position data in a vehicle may be provided. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another and/or which may operate as input and/or output devices. In one instance, the computer-implemented method may be performed by one or more processors of a computing system in communication with one or more data sources, the computer-implemented method including: (1) receiving, by the one or more processors, baseline data from one or more data stores, wherein the baseline data includes child safety seat data, vehicle data, and/or child biometric data; (2) receiving, by the one or more processors, dynamic data from a plurality of sensors, wherein at least one of the plurality of sensors is coupled to a child safety seat; (3) inputting, by the one or more processors, the baseline data and the dynamic data into a machine-learning model, wherein the machine-learning model is configured to determine a recommended adjustment for the child safety seat; (4) determining, by the one or more processors, a completion of the one or more recommended actions; (5) in response to the inputting, receiving, by the one or more processors, a recommended adjustment from the machine-learning model; (6) generating, by the one or more processors, an alert including the recommended adjustment; and/or (7) outputting, by the one or more processors, the alert via a user interface of a mobile device. The method may include additional, less, or alternate functionality, including that discussed elsewhere herein.

In a further aspect, an exemplary embodiment of a computer-implemented method for analyzing child safety seat data based upon accident data may be provided. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another and/or which may operate as input and/or output devices. In one instance, the computer-implemented method may be performed by one or more processors of a computing system in communication with one or more data sources. The method may include: (1) receiving, by the one or more processors, baseline data from one or more data stores, wherein the baseline data includes child safety seat data of a child safety seat, vehicle data of a vehicle, and/or child biometric data of a child; (2) receiving, by the one or more processors, accident data indicating that the vehicle has been in an accident; (3) in response to receiving the accident data, requesting, by the one or more processors, updated vehicle data from one or more devices; (4) receiving the accident data, requesting, by the one or more processors, updated child biometric data from a plurality of sensors, wherein at least one of the plurality of sensors is coupled to the child safety seat; (5) inputting, by the one or more processors, the baseline data, the updated vehicle data, and the updated child biometric data into a machine-learning model; (6) based upon the inputting, receiving, by the one or more processors, an indication that the baseline data, the updated vehicle data, and/or the updated child biometric data surpass an alert threshold; and/or (7) transmitting, by the one or more processors, the indication to one or more external services. The method may include additional, less, or alternate functionality, including that discussed elsewhere.

In a further aspect, an exemplary embodiment computer-implemented method for selecting a child safety seat may be provided. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another and/or which may operate as input and/or output devices. In one instance, the computer-implemented method may be performed by one or more processors of a computing system in communication with one or more data sources. The method may include: (1) receiving, by the one or more processors, baseline data from one or more data stores, wherein the baseline data includes child safety seat data, vehicle data, and/or child biometric data; (2) receiving, by the one or more processors, dynamic data from a plurality of sensors, wherein at least one of the plurality of sensors is coupled to a child safety seat; (3) comparing, by the one or more processors, the baseline data and the dynamic data to child safety seat specification data; (4) based upon the comparing, determining, by the one or more processors, that the child safety seat surpasses a replacement threshold; (5) inputting, by the one or more processors, the baseline data and the dynamic data into a machine-learning model, wherein the machine-learning model is configured to select a replacement child safety seat based upon the baseline data and the dynamic data; (6) receiving, by the one or more processors, a replacement child safety seat recommendation from the machine-learning model, wherein the replacement child safety seat recommendation includes replacement child safety seat model data; (7) generating, by the one or more processors, an alert comprising the replacement child safety seat recommendation; and/or (8) outputting, by the one or more processors, the alert via a user interface of a mobile device. The method may include additional, less, or alternate functionality, including that discussed elsewhere herein.

It is to be understood that both the foregoing general description and the following detailed description are exemplary and explanatory only and are not restrictive of the disclosed embodiments, as claimed.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

There are shown in the drawings arrangements which are presently discussed, it being understood, however, that the present embodiments are not limited to the precise arrangements and are instrumentalities shown, wherein:

FIG. 1 depicts an exemplary networked computing environment that may be utilized with techniques presented herein, according to one or more embodiments.

FIG. 2 depicts a flowchart of an exemplary computer-implemented method for analyzing installation and condition of a child safety seat, according to one or more embodiments.

FIG. 3 depicts a flowchart of an exemplary computer-implemented method for determining a child safety seat selection for a child, according to one or more embodiments.

FIG. 4 depicts a flowchart of an exemplary computer-implemented method for analyzing child safety seat position data in a vehicle, according to one or more embodiments.

FIG. 5 depicts a flowchart for analyzing a condition of a child in a child safety seat, according to one or more embodiments.

FIG. 6 depicts a flowchart for an exemplary computer-implemented method for selecting a child safety seat, according to one or more embodiments.

FIG. 7 depicts an exemplary computing device that may execute the techniques described herein, according to one or more embodiments.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments relate to, inter alia, computer systems and computer-based methods for generating a customized output (e.g., video output, text-based output, and/or audio output) based upon baseline and dynamic data of the child safety seat.

Drivers may desire to have the correct installation and selection of child safety seats while transporting children. The use of the appropriate child safety seat may be imperative to the safety and comfort of children in vehicles. However, guidelines and standards for child safety seats are constantly being updated based upon new safety and health information, even though a single child safety seat may be used for years at a time.

Additionally, adults may not be aware of the specifications and limitations of the child safety seats that are installed or used in their vehicles, especially with rapidly growing children. The rapidly changing information and growth of children may mean that children are upgraded to new child safety seats too early or too late for their size. The adult users may also be unaware of expiration dates for the child safety seats. Further, defects in child safety seats may not be easily recognizable.

As a result, there is a need for improvements in child safety seat analysis, installation, and selection that incorporate updated guidelines and standards for child safety seat use. These improvements may increase safety for children in vehicles, especially in the event an accident occurs when it is critical that the child is in an appropriately sized and maintained child safety seat.

One or more machine-learning model and/or generative Artificial Intelligence (“AI”) models may analyze data collected from a child safety seat, child, vehicle, and/or input via a user device to determine recommendations regarding installation, adjustments, replacement, and/or selection of a child safety seat. The machine-learning model may have been previously trained to analyze child safety seat data, vehicle data, and/or child biometric data in reference to a child safety seat. The sensor data, image data, and/or audio data may be input into the machine-learning model to analyze the child safety seat and determine a recommendation. The machine-learning model may provide the recommendation to one or more processors of a mobile device and/or server system regarding the installation, adjustments, replacement, and/or selection of a child safety seat in view of the child safety seat data, vehicle data, and/or child biometric data.

Such systems and methods may include several advantages. First, the systems and methods may increase safety of children in child safety seats. For example, the machine-learning model may analyze the baseline data and dynamic data collected to determine that the child is not properly fastened in the child safety seat. The same data may be used to determine that the child safety seat has not been installed properly, the child is not in the appropriately sized or type of child safety seat, the condition of the child safety seat is degraded such that it should not be used, and/or other types of safety determinations regarding child safety seats. This may result in a more accurate use of child safety seats and confirm that children are in a safe and comfortable child safety seat.

Second, the systems and methods may reduce harm or injury to the child in the event of an accident or emergency. For example, the machine-learning model may analyze dynamic data in real-time to check the condition of a child in the child safety seat. Dynamic data may include child safety seat data, vehicle data, and/or child biometric data from a plurality of sensors coupled to the child safety seat. If an accident or distress is determined based upon the analysis of the dynamic data, emergency services may be automatically contacted for assistance.

As will be discussed in more detail below, in various embodiments, systems and methods are described for generating a customized output (e.g., video output, text-based output, and/or audio output) based upon the analysis of baseline data and dynamics data related to a child, child safety seat, and/or vehicle. The systems and methods may include (i) receiving, by the one or more processors, baseline data from one or more data stores, wherein the baseline data includes child safety seat data, vehicle data, and/or child biometric data; (ii) receiving, by the one or more processors, dynamic data from a plurality of sensors, wherein at least one of the plurality of sensors is coupled to a child safety seat; (iii) inputting, by the one or more processors, the baseline data and the dynamic data into a machine-learning model, wherein the machine-learning model is configured to determine a recommended adjustment for the child safety seat; (iv) in response to the inputting, receiving, by the one or more processors, a recommended adjustment from the machine-learning model; (v) generating, by the one or more processors, an alert including the recommended adjustment; and/or (vi) outputting, by the one or more processors, the alert via a user interface of a mobile device.

In a further aspect, an exemplary embodiment of a computer-implemented method for analyzing child safety seat data based upon accident data may be provided. The computer-implemented method may be performed by one or more processors of a computing system in communication with one or more data sources. The method my include (1) receiving, by the one or more processors, baseline data from one or more data stores, wherein the baseline data includes child safety seat data of a child safety seat, vehicle data of a vehicle, and/or child biometric data of a child. The method may further include (2) receiving, by the one or more processors, accident data indicating that a vehicle has been in an accident; and/or (3) in response to receiving the accident data, requesting, by the one or more processors, updated vehicle data from one or more devices. The method may further include (4) in response to receiving the accident data, requesting, by the one or more processors, updated child biometric data from a plurality of sensors, wherein at least one of the plurality of sensors is coupled to the child safety seat. The method may further include (5) inputting, by the one or more processors, the baseline data, the updated vehicle data, and the updated child biometric data into a machine-learning model; and/or (6) based upon the inputting, receiving, by the one or more processors, an indication that the baseline data, the updated vehicle data, and the updated child biometric data surpasses an alert threshold. The method may further include (7) transmitting, by the one or more processors, the indication to one or more external services.

In a further aspect, an exemplary embodiment of a computer-implemented method for selecting a child safety seat may be provided. The computer-implemented method may be performed by one or more processors of a computing system in communication with one or more data sources. The method may include (1) receiving, by the one or more processors, baseline data from one or more data stores, wherein the baseline data includes child safety seat data, vehicle data, and/or child biometric data. The method may further include (2) receiving, by the one or more processors, dynamic data from a plurality of sensors, where at least one of the plurality of sensors is coupled to a child safety seat; and/or (3) comparing, by the one or more processors, the baseline data and dynamic data to child safety seat specification data. The method may further include (4) based upon the comparing, determining, by the one or more processors, that the child safety seat surpasses a replacement threshold; and/or (5) inputting, by the one or more processors, the baseline data and the dynamic data into a machine-learning model, wherein the machine-learning model is configured to select a replacement child safety seat based upon the baseline data and the dynamic data. The method may further include (6) receiving, by the one or more processors, a replacement child safety seat recommendation from the machine-learning model, wherein the replacement child safety seat recommendation includes replacement child safety seat model data. The method may further include (7) generating, by the one or more processors, an alert comprising the replacement child safety seat recommendation; and/or (8) outputting, by the one or more processors, the alert via a user interface of a mobile device.

### EXEMPLARY COMPUTING ENVIRONMENT

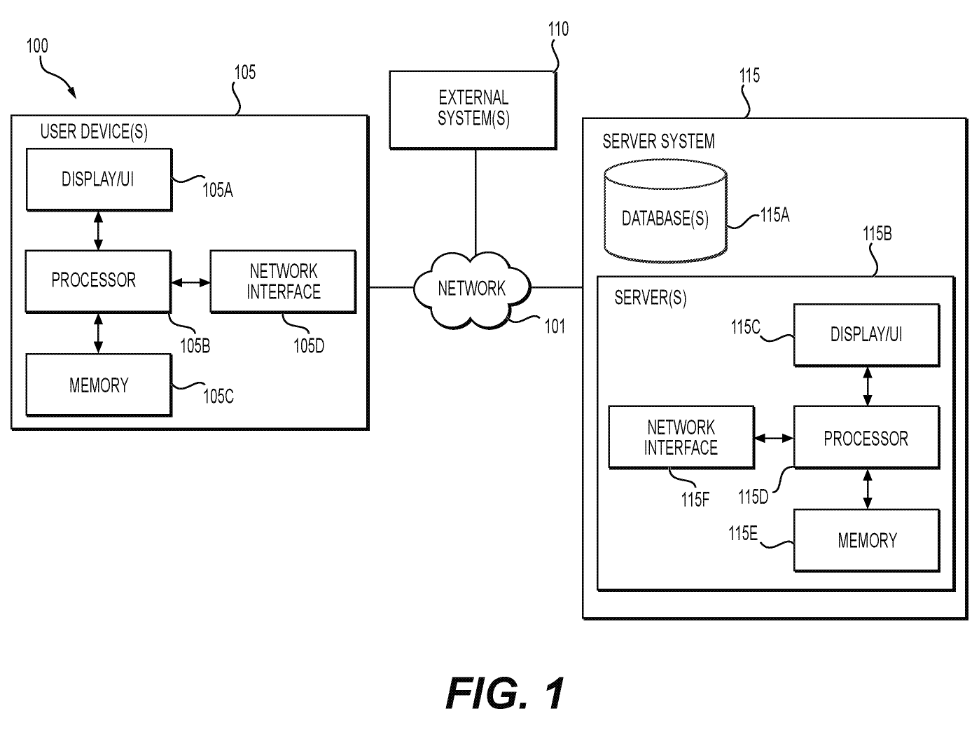

FIG. 1 depicts an exemplary computing environment 100 that may be utilized with techniques presented herein. One or more user device(s) 105, one or more external system(s) 110, and one or more server system(s) 115 may communicate across a network 101. As will be discussed in further detail below, one or more server system(s) 115 may communicate with one or more of the other components of the environment 100 across network 101. The one or more mobile device(s) 105 may be associated with a user, e.g., a user associated with one or more of generating, training, or tuning a machine-learning model for analyze child safety seat data, and, more specifically, for generating a customized output (e.g., video output, text-based output, and/or audio output) based upon baseline and dynamic data of the child safety seat.

In various embodiments, the components of the environment 100 are associated with a common entity. In various embodiments, one or more of the components of the environment is associated with a different entity than another. The systems and devices of the environment 100 may communicate in any arrangement. As will be discussed herein, systems and/or devices of the environment 100 may communicate in order to one or more of generate, train, and/or use a machine-learning model to analyze child safety seat data, and, more specifically, for generating a customized output (e.g., video output, text-based output, and/or audio output) based upon baseline and dynamic data of the child safety seat.

The mobile device 105 may be configured to enable the user to access and/or interact with other systems in the environment 100. For example, the mobile device 105 may be a computer system such as, for example, a desktop computer, a mobile device, a tablet, an in-vehicle computer system, infotainment system, etc. In various embodiments, the mobile device 105 may include one or more electronic application(s), e.g., a program, plugin, browser extension, etc., installed on a memory of the mobile device 105.

In certain embodiments, environment 100 may comprise multiple mobile devices 105. For example, a mobile device, such as a smartphone, tablet, and a vehicle computer system may be used in conjunction in environment 100.

The mobile device 105 may include a display/user interface (UI) 105A, a processor 105B, a memory 105C, and/or a network interface 105D. The mobile device 105 may execute, by the processor 105B, an operating system (O/S) and at least one electronic application (each stored in memory 105C). The electronic application may be a desktop program, a browser program, a web client, or a mobile application program (which may also be a browser program in a mobile O/S), an applicant specific program, system control software, system monitoring software, software development tools, or the like. For example, environment 100 may extend information on a web client that may be accessed through a web browser.

In various embodiments, the electronic application(s) may be associated with one or more of the other components in the environment 100. The application may manage the memory 105C, such as a database, to transmit streaming data to network 101. The display/UI 105A may be a touch screen or a display with other input systems (e.g., mouse, keyboard, etc.) so that the user(s) may interact with the application and/or the O/S. The network interface 105D may be a TCP/IP network interface for, e.g., Ethernet or wireless communications with the network 101. The processor 105B, while executing the application, may generate data and/or receive user inputs from the display/UI 105A and/or receive/transmit messages to the server system 115, and may further perform one or more operations prior to providing an output to the network 101.

External systems 110 may be, for example, one or more third party and/or auxiliary systems that integrate and/or communicate with the server system 115 in performing various output customization tasks. For example, the external systems 110 may comprise the child safety seat(s) (e.g., sensors attached to the child safety seat(s)), vehicle computer system, emergency services, insurance services, etc.

Further, external systems 110 may be in communication with other device(s) or system(s) in the environment 100 over the one or more networks 101. For example, external systems 110 may communicate with the server system 115 via API (application programming interface) access over the one or more networks 101, and also communicate with the mobile device(s) 105 via web browser access over the one or more networks 101. External systems 110 may additionally communicate with one or more other external systems regarding relevant data in environment 100. Additionally or alternatively, a vehicle computer system may communicate with a child safety seat, emergency services, and/or insurance services

In various embodiments, the network 101 may be a wide area network (“WAN”), a local area network (“LAN”), a personal area network (“PAN”), or the like. In various embodiments, network 101 includes the Internet, and information and data provided between various systems occurs online.

“Online” may mean connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The server system 115 may include an electronic data system, e.g., a computer-readable memory such as a hard drive, flash drive, disk, etc. In various embodiments, the server system 115 includes and/or interacts with an application programming interface for exchanging data to other systems, e.g., one or more of the other components of the environment.

The server system 115 may include a database 115A and at least one server 115B. The server system 115 may be a computer, system of computers (e.g., rack server(s)), and/or or a cloud service computer system. The server system may store or have access to database 115A (e.g., hosted on a third-party server or in memory 115E). The server(s) may include a display/UI 115C, a processor 115D, a memory 115E, and/or a network interface 115F. The display/UI 115C may be a touch screen or a display with other input systems (e.g., mouse, keyboard, etc.) for an operator of the server 115B to control the functions of the server 115B. The server system 115 may execute, by the processor 115D, an operating system (O/S) and at least one instance of a servlet program (each stored in memory 115E).

The server system 115 may generate, store, train, or use a machine-learning model, configured to generate a customized output based upon baseline data, dynamic data, and/or sensor data. For example, baseline data and account data may be received and stored by server system 115. Baseline data and dynamic data may be described in further detail in the method below. Baseline data and dynamic data may include stored baseline data and dynamic data, as well as previous outputs of the machine-learning model(s). The baseline data, dynamic data, and/or sensor data may be input into the machine-learning model to generate recommendation(s) and/or output(s) regarding analysis of one or more child safety seats.

The server system 115 may include a machine-learning model and/or instructions associated with the machine-learning model, e.g., instructions for generating a machine-learning model, training the machine-learning model, using the machine-learning model, etc. The server system 115 may include instructions for customizing outputs based upon baseline data, dynamic data, and/or sensor data, e.g., based upon the output of the machine-learning model, and/or operating the display 115C to output an alert, e.g., as adjusted based upon the machine-learning model. The server system 115 may include training data.

In various embodiments, a system or device other than the server system 115 is used to generate and/or train the machine-learning model. For example, such a system may include instructions for generating the machine-learning model, the training data and ground truth, and/or instructions for training the machine-learning model. A resulting trained machine-learning model may then be provided to the server system 115.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based upon Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In various embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between user literacy, audio output, and assets (e.g., stocks), such that the trained machine-learning model is configured to determine a user’s literacy level and provide audio output based upon the learned associations.

In various embodiments, the variables of a machine-learning model may be interrelated in any suitable arrangement in order to generate the output. For example, the machine-learning model may include one or more convolutional neural network (“CNN”) configured to identify user preferences (e.g., a user literacy level), and may include further architecture, e.g., a connected layer, neural network, etc., configured to determine a relationship between baseline data and/or dynamic data of a child safety seat, vehicle data, and/or child biometric data.

Further aspects of the machine-learning model and/or how it may be utilized to generate a customized output based upon baseline data, dynamic data, sensor data, and/or other received data may be described in further detail in the method below. In the following method, various acts may be described as performed or executed by a component from FIG. 1, such as the server system 115, the mobile device 105, or components thereof. However, it should be understood that in various embodiments, various components of the environment 100 discussed below may execute instructions or perform acts including the acts discussed below. An act performed by a device may be considered to be performed by a processor, actuator, or the like associated with that device. Further, it should be understood that in various embodiments, various blocks may be added, omitted, and/or rearranged in any suitable manner.

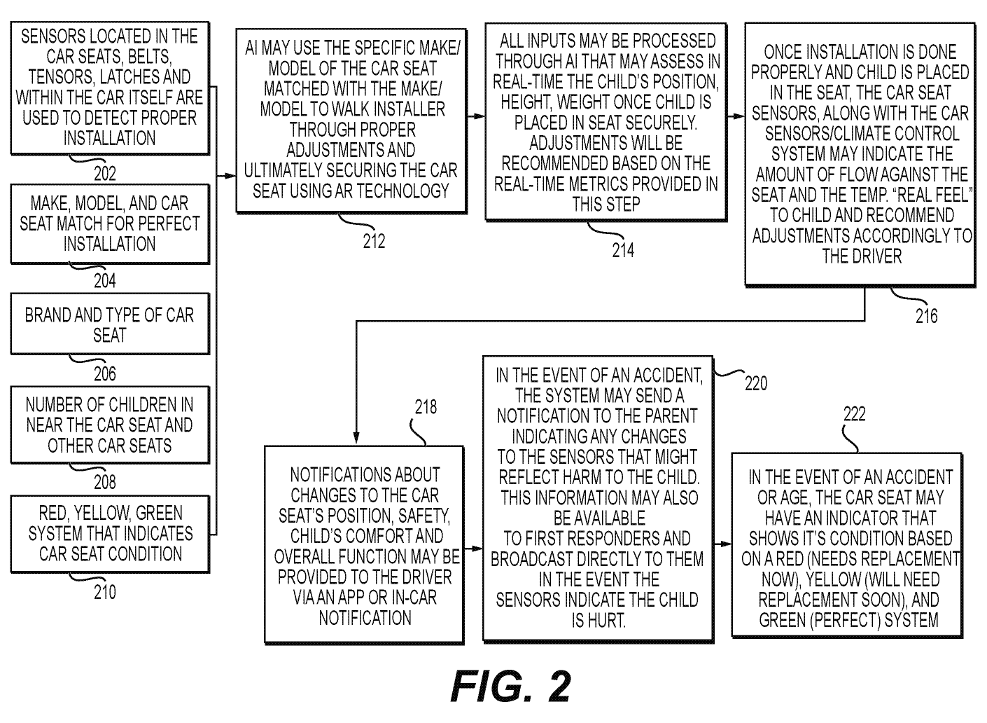

In general, any process or operation discussed in this disclosure that is understood to be computer-implementable, such as the processes illustrated in FIGS. 2-6, may be performed by one or more processors of a computer system, such any of the systems or devices in the environment 100 of FIG. 1, as described above. A process or process block performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples below, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

Although depicted as separate components in FIG. 1, it should be understood that a component or portion of a component in the environment 100 may, in various embodiments, be integrated with or incorporated into one or more other components. For example, a portion of the display 115C may be integrated into the mobile device 105 or the like. In various embodiments, operations or aspects of one or more of the components discussed above may be distributed amongst one or more other components. Any suitable arrangement and/or integration of the various systems and devices of the environment 100 may be used.

### EXEMPLARY COMPUTER-BASED METHOD FOR ANALYZING SAFETY SEAT

FIG. 2 depicts a flowchart of an exemplary computer-implemented or computed-based method 200 for analyzing a child safety seat based upon baseline data, dynamic data, and/or sensor data, according to one or more embodiments. Method 200 may be performed by one or more processors of a server that is in communication with one or more mobile devices and other external system(s) via a network. However, it should be noted that method 200 may be performed by any one or more of the server, one or more user devices, or other external systems.

Computer-implemented method 200 may include receiving, by one or more processors, baseline data from one or more data stores (204 and 208) and receiving, by the one or more processors, dynamic data from a plurality of sensors (202, 206, and 210). In various embodiments, the baseline data may comprise child safety seat data, vehicle data, and/or child biometric data. Dynamic data may comprise child safety seat data, vehicle data, and/or child biometric data from the plurality of sensors coupled to the child safety seat.

The baseline data may include data that is expected to be consistent for a plurality of uses of the child safety seat. For example, vehicle data that is considered to be baseline data may include a make and/or a model of the vehicle, which may be updated through a user interface of a mobile device, but is expected to remain consistent between uses of the child safety seat. Additionally, or alternatively, the baseline data may include the number of children, or other passengers, near the car seat (e.g., in other seats of the vehicle).

The dynamic data may include data that may change between and/or during use of the child safety seat. For example, vehicle data that is considered to be dynamic data may include environmental data (e.g., temperature, number of occupied seats in the vehicle, speed, location, etc.). In various embodiments, the dynamic data may be received from a plurality of sensors coupled to the child safety seat, seat belts, tensors, latches, sensors within the vehicle (e.g., external systems 110), as well as data from one or more mobile devices (e.g., mobile device(s) 105).

The computer-implemented method 200 may include one or more sensors being coupled to the child safety seat 202. In various embodiments, the sensors may be attached to one or more fastening devices (e.g., belts, tensors, latches, etc.) and/or within the child safety seat itself. In various embodiments, the sensors may include a variety of sensors used to detect position, weight, movement, environmental conditions, and/or other collectable data that may be relevant to the position of the child in the child safety seat. For example, a plurality of sensors may be used to collect biometric data as a baseline and dynamically while the child is positioned in the child safety seat. A weight sensor (e.g., a pressure sensor) may be attached to the child safety under the child to determine the weight of the child in the seat.

One or more sensors may be attached to the latches over the chest of the child in the child safety seat to detect other biometric data such as heart rate and breathing. A plurality of sensors may be attached to the child safety seat to detect environmental conditions such as ambient temperature data, light data, audio data, and the like.

In various embodiments, the child safety seat may include accelerometer and/or position sensors to collect physical information about the child positioned in the child safety seat. For example, the plurality of sensors may provide data that indicates a sudden movement has been made by the child, e.g., a sudden stop of the vehicle may cause the child or lean forward rapidly. This may result in distress to the child or an unsafe adjustment to the child safety seat, e.g., the child safety seat shifted, a buckle opened, tethers became, and/or other child safety adjustments. Rapid movement could additionally indicate the child is in distress or result in the child being distressed.

The plurality of sensors may collect data in real-time which may be analyzed by a machine-learning model to determine if the child is in distress or adjustments should be made to the child safety seat. In various embodiments, the child safety seat may include or communicate with a camera and/or video system to collect visual data of the child and/or child safety seat. For example, 2D images, stereoscopic images, and/or video may be collected to assess the child and/or child safety seat. In various embodiments, mobile device(s) 105 may connect or communicate via a network (e.g., network 101) with a health monitoring wearable device (e.g., external system(s) 110) to collect the child biometric data.

The computer-implemented method 200 may include the system receiving and/or obtaining information regarding the child safety seat 204. In various embodiments, the system may receive the child safety seat data via a mobile device (e.g., mobile device 105). For example, using one or more electronic applications, child safety seat data may be input via a user interface of the application and/or scanned using a camera of the mobile device (e.g., capturing and image or video of the child safety seat, scanning a barcode or quick response code, etc.). In various embodiments, the user interface of the electronic application may display a selection of potential child safety seat options, and upon selection the child safety seat information, the selected child safety seat options may be imported from an external source (e.g., external system(s) 110) via a network (e.g., network 101). In various embodiments, the child safety seat data may be collected from multiple mobile devices. For example, a smartphone and vehicle computer system may both provide data regarding the child safety seat to the system.

The computer-implemented method 200 may include the system collecting information regarding the transportation device (e.g., the vehicle) 206. In various embodiments, the child safety seat may be installed in a vehicle, such as a car, van, truck, and the like. The make and model of the vehicle may be used in conjunction with the child safety seat model from Block 204, in order to determine the optimal installation of the car seat. For example, a child safety seat installed in a vehicle with a first make and model may have an optimal installation that is different from a vehicle with a second make and model, even though the child safety seat is the same in both vehicles.

In various embodiments, the optimal installation may include seat position, attachment points (such as anchor and tether points), and/or instructions for tightening and further positioning the child safety seat. In various embodiments, the transportation device may have a form of transportation other than a vehicle, such as a stroller, bus, train, airplane, or other form of transit. Additionally or alternatively, a user may provide user input via a user interface (e.g., display/UI 105A of mobile device(s) 105), where the user input may include updated vehicle and/or transportation device data.

The user interface (e.g., display/UI 105A) may display a selection of transportation devices that have been used before with the child safety seat. For example, a family may user two or more vehicles, where the child safety seat may be transferred between the vehicles.

The computer-implemented method 200 may include system identifying a number of occupied seats in the vehicle 208. In various embodiments, the occupied seats may be determined using the existing vehicle computer system (e.g., pressure sensors in individual seats, cameras used to monitor the interior of the vehicle, and/or other sensors employed by the vehicle computer system to monitor the vehicle). The number of occupied seats may also be input via the user interface of the electronic application.

The number of occupied seats may a factor in determining the optimal position of the child safety seat while the child is positioned in the child safety seat. For example, in a vehicle with three seats in a row, the optimal child safety seat position may change depending on whether there are no other occupied seats, 1 or 2 occupied seats, and the like. In various embodiments, the system may determine if the occupied seats are occupied by a child or adult. The estimated age of the occupant of the seat may influence the optimal position of the child safety seat. In various embodiments, the system may use a machine-learning model to determine an estimated age of the occupant of the seat.

The computer-implemented method 200 may include the system providing an initial indication of the condition of the child safety seat 210. For example, a color-coded alert may indicate the condition of the child safety seat, where green may correspond to a high condition, yellow may correspond to a moderate condition, and red may correspond to a low condition.

A high condition may indicate the child safety seat is optimal for use, the child safety seat does not have any detectable defects, and/or any detectable defects are within a tolerance, threshold of safety guidelines, or standards for the child safety seat. A moderate condition may indicate that the child safety seat has detectable defects beyond the high condition, but the detectable defects are within the safety guidelines or standards for child safety seat. A low condition may indicate the child safety seat has detectable defects that exceed the tolerance or threshold of safety guidelines or standards for the child safety seat, where the child safety seat should not be used.

In various embodiments, the sensors described in Blocks 204–208 may be used to detect the condition of the child safety seat. For example, a pressure sensor may validate the correct weight of the child safety seat prior to a child’s placement or positioning in the child safety seat. A camera may capture images of the child safety seat, which may be assessed to detect any physical defects or abnormalities in the child safety seat.

In various embodiments, a machine-learning model may utilize data from the sensors, images, and/or other user interface of the electronic application to assess the condition of the child safety seat. For example, the machine-learning model may have been previously trained to receive the data from the sensors, images, and/or other user interface, and in response to receiving the data, the machine-learning model may output a condition of the child safety seat.

The computer-implemented method 200 may include a machine-learning model using the data from Blocks 204–210 to determine any adjustments to the position of the child safety seat 210. For example, based upon the child safety seat data (e.g., the brand, type, model, serial number, etc.) and the dynamic data, the machine-learning model may determine that the child safety seat is installed incorrectly. For example, installation errors may include situations where the anchors or tethers may have been incorrectly attached to the seat, the child safety seat may have been installed in a forward-facing position when it is designed to be installed in a rear-facing position, and the like.

In various embodiments, augmented reality (AR) and/or virtual reality (VR) and/or mixed reality) may be used to indicate the recommended adjustments to the child safety seat. For example, one or more processors (e.g., processor 105B, processor 115D) may generate an augmented or virtual reality interface to indicate the adjustments to the child safety seat, based upon the determination at Block 212. In various embodiments, one or more processors may generate an alert and output the alert to a mobile device. The alert may include visual data (e.g., text data, image data, and/or video data) and/or audio data indicating the suggested adjustments to the child safety seat.

The computer-implemented method 200 may include, once the child is placed in the child safety seat, a machine-learning model using baseline data and dynamic data from Blocks 204–210 to determine any adjustments that should be made to the child or the child safety seat 212. For example, a pressure sensor of the plurality of sensors coupled to the child safety seats may indicate that the buckles or tethers of the child safety seat should be tightened to properly fit the child. In various embodiments, the dynamic data may be continuously collected in real-time.

One or more processors may periodically transmit the baseline and dynamic data to a machine-learning model to confirm the child is still properly positioned in the child safety seat. For example, during a drive, the child may move and cause the harnesses of the child safety seat to loosen, where the plurality of sensors may collect data indicating the harness should be re-tightened.

The method 200 may include, the plurality of sensors collecting the environmental data relevant to the child and the child safety seat 216. The plurality of sensors may detect ambient temperature data, flow rate data of air-conditioning or heat, light data, noise level data, and/or other environmental condition data. For example, a temperature sensor and/or flow rate sensor may collect data regarding the ambient temperature and flow rate against the child safety seat from the climate control system of the vehicle.

A machine-learning model may analyze this data (e.g., dynamic data) to recommend an adjustment. For example, if the climate control system is set to a low temperature with a high flow rate, it may be too cold for the child in the safety seat. This may also be supported by the child biometric data collected as a part of the dynamic data collected by the plurality of sensors. The machine-learning model may recommend an adjustment to the temperature, flow rate, and/or a combination of the climate control system. The recommended adjustment may be output as an alert to the one or more mobile device(s) 105, as described in Blocks 212–214.

The computer-implemented method 200 may include the mobile device(s) 105, server system 115, and/or external system(s) 110 transmitting alerts indicating one or more adjustments to the child safety seat, child position, and/or environment that are relevant to the safety and/or comfort of the child in the child safety seat 218. In various embodiments, mobile device(s) 105 may include an electronic application to facilitate communication with the server system (e.g., server system 115) and/or a network (e.g., network 101). The electronic application may include a user interface (e.g., display/UI 105A) that is configured to display the alerts. As described in FIG. 1, the mobile device(s) may include a smartphone, tablet, vehicle computing system, or other mobile computer device.

The computer-implemented method 200 may include the plurality of sensors being coupled to the child safety seat and/or data from the mobile device(s) detecting accident data 220. For example, the accident data may include an automatic braking alert, crash detection of a vehicle computing system, rapid deceleration, child biometric data indicating severe stress, and/or similar data indicating an accident and/or medical emergency. A machine-learning model may analyze the data to determine whether one or more external services (e.g., emergency services, first responders, police department, etc.) should be contacted. The system may send a notification or alert to the one or more external services. The notification may include the accident data, location data, and/or child biometric data. In the event that the mobile device(s) may be unable to communicate with the external system(s) as a result of the accident, the server system may transmit the notification and data to the emergency services systems.

The computer-implemented method 200 may include the system providing an updated indication of the condition of the child safety seat in response to the accident 222. As described with reference to Block 210, a color-coded alert may indicate the condition of the child safety seat, where green corresponds to a high condition, yellow corresponds to a moderate condition, and red corresponds to a low condition.

A high condition may indicate the child safety seat is optimal for use, the child safety seat does not have any detectable defects, and/or any detectable defects are within a tolerance, threshold of safety guidelines, or standards for the child safety seat. A moderate condition may indicate that the child safety seat has detectable defects beyond the high condition, but the detectable defects are within the safety guidelines or standards for child safety seat. A low condition may indicate the child safety seat has detectable defects that exceed the tolerance or threshold of safety guidelines or standards for the child safety seat, where the child safety seat should not be used.

In various embodiments, the sensors described in blocks 204–208 may be used to detect the condition of the child safety seat. In another example, a camera may capture images or video of the child safety seat which may be assessed to detect any physical defects or abnormalities in the child safety seat. In various embodiments, a machine-learning model may utilize data from the sensors, images, and/or other user interface of the electronic application to assess the condition of the child safety seat.

In various embodiments, the child safety seat condition may be updated in response to the age of the child safety seat (e.g., an expiration). The system may compare the baseline data collected at Block 206 with current dynamic data to determine if, and when, the child safety seat will expire. For example, a purchase date of the child safety seat (e.g., baseline data) may be compared with the current date (e.g., dynamic data) to determine the child safety seat has expired or will expire in the near future (e.g., day(s), week(s), and/or month(s)).

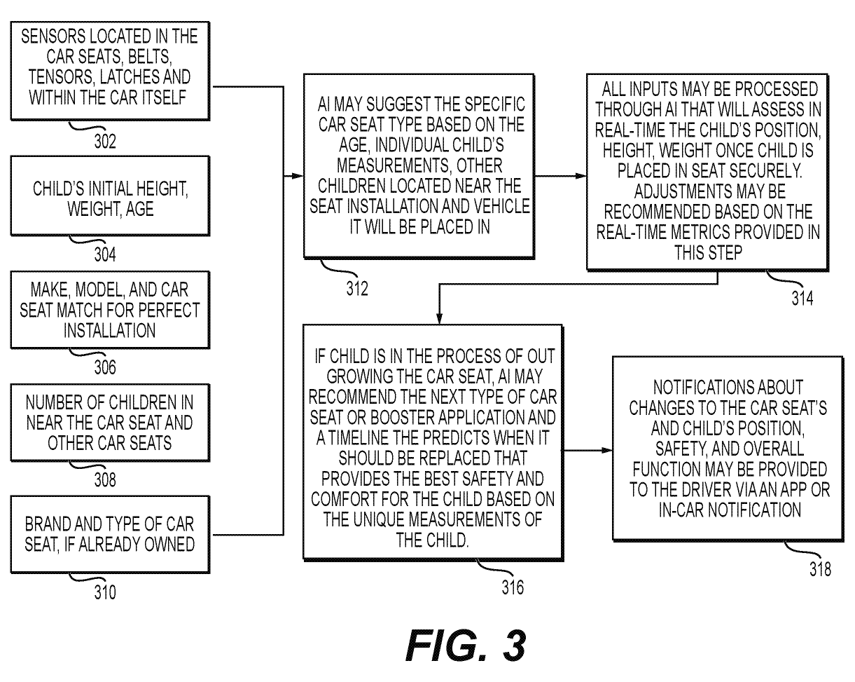

The one or more processors may generate an alert to indicate the expiration of the child safety seat. As described with reference to FIG. 3, the machine-learning model may determine a recommend replacement child safety seat. In various embodiments, the one or more processors may generate periodic reminders (e.g., day(s), week(s), and/or month(s)) prior to the expected expiration of the child safety seat, in order to allow the user to obtain a replacement child safety seat while the current child safety seat is still safe and comfortable for the child.

Although FIG. 2 shows example blocks of exemplary computer-implemented method 200, in some implementations, the exemplary method 200 may include additional blocks, fewer blocks, different blocks, or differently arranged blocks than those depicted in FIG. 2. Additionally, or alternatively, two or more of the blocks of the exemplary computer-implemented method 200 may be performed in parallel.

### EXEMPLARY COMPUTER-IMPEMENTED METHOD FOR SELECTING SEAT

FIG. 3 depicts a flowchart of an exemplary computer-implemented method 300 for selecting a child safety seat based upon collected baseline data and dynamic data, according to one or more embodiments. Method 300 may be performed by one or more processors of a server that is in communication with one or more mobile devices and other external system(s) via a network. However, it should be noted that method 300 may be performed by any one or more of the server, one or more user devices, or other external systems.

The computer-implemented method 300 may include receiving, by one or more processors, baseline data from one or more mobile device(s) 105 and/or data stores (304, 308, and 310) and receiving, by the one or more processors, dynamic data from a plurality of sensors (302 and 306). In various embodiments, the baseline data may comprise child safety seat data, vehicle data, and/or child biometric data. Dynamic data may comprise child safety seat data, vehicle data, and/or child biometric data from the plurality of sensors coupled to the child safety seat.

The baseline data may include data that is expected to be consistent for a plurality of uses of the child safety seat. For example, vehicle data that is considered to be baseline data may be make and/or model of the vehicle, which may be updated through a UI of a mobile device, but is expected to remain consistent between uses of the child safety seat.

Dynamic data may include data that may change between and/or during use of the child safety seat. For example, vehicle data that may be considered to be dynamic data may include environmental data (e.g., temperature data), number of occupied seats in the vehicle, vehicle speed, vehicle location, etc. In various embodiments, the dynamic data may be received from a plurality of sensors coupled to the child safety seat as well as data from one or more mobile devices (e.g., mobile device(s) 105).

The computer-implemented method 300 may include one or more sensors being coupled to the child safety seat 302. In various embodiments, the sensors may be attached to fastening devices (e.g., belts, tensors, latches, harnesses, etc.) and/or within the child safety seat itself. In various embodiments, the sensors may include a variety of sensors used to detect position data, weight data, movement data, environmental conditions, and/or other collectable data that may be relevant to the position of the child in the child safety seat. For example, a plurality of sensors may be used to collect the biometric data and establish a baseline, where the sensors may also dynamically collect the biometric data throughout the child’s use of the child safety seat. A weight sensor (e.g., a pressure sensor) may be attached to the child safety under the child to determine the weight of the child in the seat. One or more sensors may be attached to the latches over the chest of the child in the child safety seat to detect other biometric data such as heart rate and breathing. A plurality of sensors may be attached to the child safety seat to detect environmental conditions such as ambient temperature data, light data, audio data, and the like.

In various embodiments, the child safety seat may comprise accelerometer and position sensors to collect physical information about the child positioned in the child safety seat. For example, the plurality of sensors may provide data that indicates a sudden movement has been made by the child, e.g., a sudden stop of the vehicle may cause the child or lean forward rapidly. This may result in distress to the child or an unsafe adjustment to the child safety seat, e.g., the child safety seat shifted, a buckle opened, tethers became, and/or other child safety adjustments. Rapid movement could additionally indicate the child is in distress or result in the child being distressed. The plurality of sensors may collect data in real-time which may be analyzed by a machine-learning model to determine if the child is in distress or adjustments should be made to the child safety seat.

In various embodiments, the child safety seat may comprise or communicate with a camera and/or video system to collect visual data of the child and/or child safety seat. For example, 2D images, stereoscopic images, and/or video data may be collected to assess the child and/or child safety seat. In various embodiments, mobile device(s) 105 may connect or communicate via a network (e.g., network 101) with a health monitoring wearable device (e.g., external system(s) 110) to collect child biometric data.

The computer-implemented method 300 may include the initial height, weight, and age of the child being collected 304. In various embodiments, one or more processors may receive the initial child biometric data via user input from a user interface (e.g., display/UI 105A of mobile device(s) 105). For example, a user may input the child’s initial height, weight, and/or age into a user interface of the mobile device. In another example, the mobile device may utilize one or more electronic applications to estimate or import the child’s initial height, weight, and age.

The computer-implemented method 300 may include information regarding the transportation device being collected at Block 306. In various embodiments, the child safety seat may be installed in a vehicle. The make and model may be used in conjunction with the child safety seat model from block 204 to determine the optimal installation of the car seat. For example, a child safety seat being installed in a vehicle with a first make and model may have an optimal installation that is different than a vehicle having a second make and model, even though the child safety seat being used is the same in both vehicles.

In various embodiments, the optimal installation may include seat position, attachment points (such as anchor and tether points), and/or instructions for tightening and further positioning the child safety seat. In certain embodiments, the transportation device may be a form of transportation other have a vehicle, such as a stroller, bus, train, or other form of transit.

The computer-implemented method 300 may include the system identifying a number of occupied seats in the vehicle 308. In various embodiments, the occupied seats may be determined using the existing vehicle computer system (e.g., pressure sensors in individual seats, cameras used to monitor the interior of the vehicle, and/or other sensors employed by the vehicle computer system to monitor the vehicle). The number of occupied seats may also be input via the user interface of the electronic application.

The number of occupied seats may a factor in determining the optimal position of the child safety seat while the child is positioned in the child safety seat. For example, in a vehicle with three seats in a row, the optimal child safety seat position may change depending on whether there are no other occupied seats, 1 or 2 occupied seats, and the like. In various embodiments, the system may determine if the occupied seats are occupied by a child or adult. The estimated age of the occupant of the seat may influence the optimal position of the child safety seat. In certain embodiments, the system may use a machine-learning model to determine an estimated age of the occupant of the seat.

The computer-implemented method 300 may include the system receiving and/or obtaining information regarding the child safety seat 310. In various embodiments, the system may receive the child safety seat data via a mobile device (e.g., mobile device 105). For example, using one or more electronic applications, child safety seat data may be input via a user interface of the application and/or scanned using a camera of the mobile device (e.g., capturing and image or video of the child safety seat, scanning a barcode or quick response code, etc.).

In various embodiments, the user interface of the electronic application may display a selection of potential child safety seat options, and upon selection the child safety seat information, the selected child safety seat options may be imported from an external source (e.g., external system(s) 110) via a network (e.g., network 101). In certain embodiments, the child safety seat data may be collected from multiple mobile devices. For example, a smartphone and vehicle computer system may both provide data regarding the child safety seat to the system.

The computer-implemented 300 may include a machine-learning model using the data from Blocks 304–310 to determine a recommended child safety seat 312. The baseline data and dynamic data collected in Blocks 304–310 may be input into a machine-learning model to determine a recommended child safety seat. For example, the child length data collected from one or more of the plurality of sensors coupled to the child safety seat may indicate that the child has outgrown the child safety seat. The machine-learning model may analyze the other child biometric data (e.g., age and weight) and other dynamic data (e.g., number of occupied seats) and baseline data (e.g., make and model of the vehicle) to determine a recommended replacement child safety seat.

In various embodiments, the machine-learning model may determine a positioning recommendation, such as switching from a rear-facing child safety seat to a front facing child safety seat, switching from a front facing child safety seat to a booster seat, and/or a switching from a booster seat to sitting in a vehicle seat without the aid of a child safety seat or a booster seat.

The computer-implemented method 300 may include the user obtaining and installing the recommended replacement child safety seat 314. Once the child is placed in the replacement child safety seat, a machine-learning model may use baseline data and dynamic data from blocks 302–310 to determine any adjustments that the user should make to the child or the child safety seat, as described with reference to Block 214 in FIG. 2.

In various embodiments, the dynamic data may be continuously collected in real-time. One or more processors may periodically transmit the baseline and dynamic data to a machine-learning model to confirm the child is still properly positioned in the child safety seat. For example, during a drive, the child may move and cause the harnesses of the child safety seat to loosen and the plurality of sensors may collect data indicating the harness should be re-tightened, when analyzed by the machine-learning model. In response to obtaining and installing the replacement child safety seat, one or more processors (e.g., processor 105B, processor 115D) may replace the previous baseline data with updated baseline data for the replacement child safety seat.

The dynamic data collected after the installation of the replacement child safety seat may become the updated baseline data. For example, the plurality of sensors may determine updated height, weight and/or child safety seat data, where the system may update the child safety seat data to reflect the replacement child safety seat.

In various embodiments, portions of the baseline data may remain consistent even when the child safety seat is replaced. For example, the occupied seat data may remain the same, the vehicle data may remain the same, the type of child safety seat (e.g., rear-facing, front-facing, or booster) may remain the same, and/or some child biometric data (e.g., age) may remain the same.

In various embodiments, augmented reality (AR) and/or virtual reality (VR) and/or mixed reality may be used to indicate the recommended adjustments to the child safety seat. For example, one or more processors (e.g., processor 105B, processor 115D) may generate an augmented reality or virtual reality interface to indicate the adjustments to the child safety seat. In certain embodiments, one or more processors may generate an alert and output the alert to mobile device(s) 105. The alert may include visual data (e.g., text data, image data, video data) and/or audio data indicating one or more recommended adjustments to the child safety seat.

The computer-implemented method 300 may include the baseline data and dynamic data being used to predict when the child may outgrow the child safety seat 316. The plurality of sensors coupled to child safety seat may continuously track and/or store dynamic data in the data stores.

A machine-learning model may analyze the baseline data and/or the dynamic data to predict a timeframe for when the child may exceed a threshold of the child safety seat specification data. For example, based upon the change in baseline and dynamic data over a six month time period, a machine-learning model may predict that the dynamic data corresponding to the child biometric data will exceed one or more thresholds of the child safety seat specification in three to six months. This may prompt a periodic alert and/or reminder to a mobile device (e.g., mobile device(s) 105) regarding an expected time frame for when the child may exceed the threshold of the child safety seat.

As in block 312, the machine-learning model may recommend a change in type of child safety seat (e.g., upgrading to front-facing, booster, or regular seat). In various embodiments, the machine-learning model may determine that the type of seat may be still appropriate based upon the current dynamic data and rate of change of baseline data to current dynamic data. However, the machine-learning model may still recommend a replacement seat that has specification data indicating it can accommodate the growth of the child. The unique measurements of the individual child may be assessed by the machine-learning model to determine the safest and most comfortable child safety seat for the child and vehicle.

The computer-implemented method 300 may include, mobile device(s) 105, server system 115, and/or external system(s) 110 transmitting alerts indicating any adjustments to the child safety seat, child position, and/or environment that are relevant to the safety and/or comfort of the child in the child safety seat 318. In various embodiments, mobile device(s) 105 may include an electronic application to facilitate communication with server system 115 and/or network 101. The electronic application may include a user interface (e.g., display/UI 105A) that is configured to display the alerts. As described in FIG. 1, the mobile device(s) may include a smartphone, tablet, vehicle computing system, or other mobile computer device.

Although FIG. 3 shows example blocks of exemplary computer-implemented method 300, in some implementations, the exemplary method 300 may include additional blocks, fewer blocks, different blocks, or differently arranged blocks than those depicted in FIG. 3. Additionally, or alternatively, two or more of the blocks of the exemplary computer-implemented method 300 may be performed in parallel.

### EXEMPLARY COMPUTER-BASED METHOD FOR ANALYZING POSITION DATA

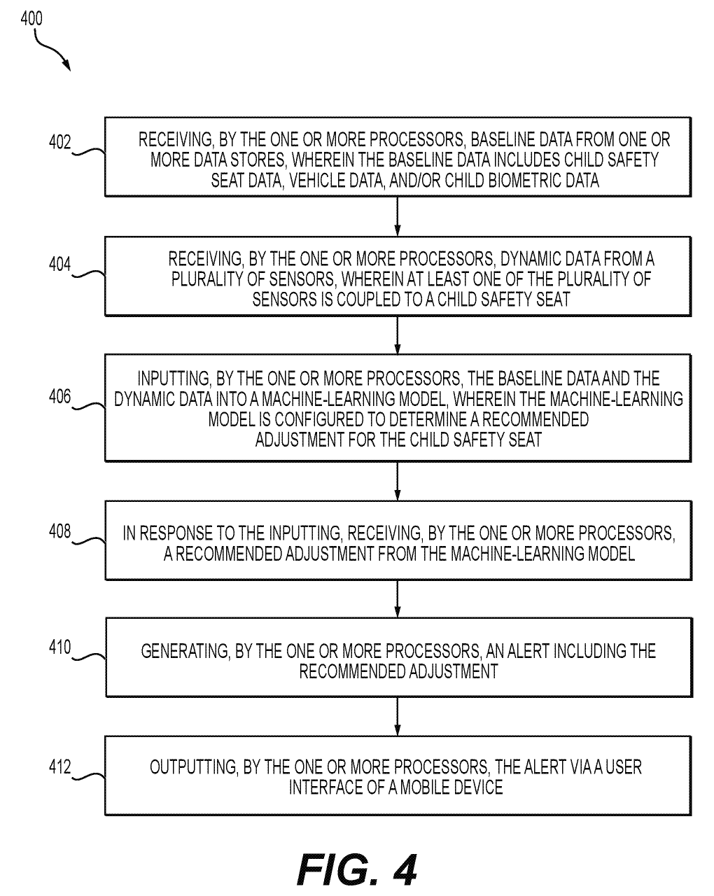

FIG. 4 depicts a flowchart of an exemplary computer-implemented method 400 for analyzing child safety seat position data based upon baseline data and dynamic data, according to one or more embodiments. Method 400 may be performed by one or more processors of a server that is in communication with one or more user devices and other external system(s) via a network. However, it should be noted that method 400 may be performed by any one or more of the server, one or more user devices, or other external systems.

The computer-implemented method 400 may include receiving, by the one or more processors (e.g., processor 105B, processor 115D), baseline data from one or more data stores (e.g., memory, 105C, memory 115E, database(s) 115A), wherein the baseline data includes child safety seat data, vehicle data, and/or child biometric data 402. For example, the data stores may receive the baseline data from one or more mobile devices (e.g., cell phones, vehicle systems, etc.). The child safety seat data may include expiration data, brand data, position data, and/or dimension data. The expiration data may correspond to an expiration date of the child safety seat. The brand data may correspond to a make and/or model of the child safety seat. The position data may correspond to one or more positions of the child safety seat, which may be determined via one or more sensors that are attached to the child safety seat. The dimension data may correspond to one or more dimensions of the child safety seat, such as the length, width, and/or height of the child safety seat.

The child biometric data may comprise child position data, child length data, and/or child weight data. The child biometric data may be input into a mobile device, retrieved from one or more child records (e.g., child medical records), and/or determined by one or more sensors (e.g., sensors attached to the child safety seat). The vehicle data may comprise vehicle date data, vehicle make data, and/or vehicle model data. The method may include accessing a computer system of a vehicle to retrieve some or all of the vehicle data. A user may input some or all of the baseline data into a mobile device (e.g., mobile device 105) via a user interface of the mobile device.

The computer-implemented method 400 may include receiving, by the one or more processors, dynamic data from a plurality of sensors, wherein at least one of the plurality of sensors is coupled to a child safety seat 404. For example, the received dynamic data may comprise ambient temperature data at the child safety seat position. The received dynamic data may include occupied seat data, wherein the occupied seat data may include one or more corresponding occupied seat locations.

In various embodiments, the vehicle may include one or more sensors that are configured to determine whether a seat is occupied, the location of the occupied seat, and/or data regarding the user(s) who are occupying a seat. Additionally, the dynamic data may include current child biometric data in relation to the position of the child in the child safety seat. For example, the biometric data may include child position data, child length data, and/or child weight data. In certain embodiments, the dynamic data may include child biometric data corresponding to respiratory rate data, heart rate data, and/or biometric data actively monitored by the sensors coupled to the child safety seat, as described with reference to FIG. 2.

In various embodiments, the computer-implemented method 400 may include creating, by the one or more processors, child profile data that includes the received baseline data and the received dynamic data and storing the child profile data in the one or more data stores (e.g., database(s) 115A). For example, a child profile may be created via an electronic application displayed on a user interface (e.g., display/UI 105A). The child biometric data, child safety seat data, and/or vehicle data may be associated with the child and/or the user (e.g., a parent or guardian of the child) and stored in one or more databases (e.g., database(s) 115A).

When a child safety seat is being used, the received dynamic data may correspond to the previously stored baseline data and dynamic data. For example, the method may include updating the child profile data to include the most recent received dynamic data. In various embodiments, the updating may further include associating a time stamp with the received dynamic data.

The computer-implemented method 400 may include inputting, by the one or more processors, the baseline data and the dynamic data into a machine-learning model, wherein the machine-learning model is configured to determine a recommended adjustment for the child safety seat 406. For example, the baseline data may include a make and model for a vehicle and/or a child safety seat, as well as an optimized position for the child safety seat in a vehicle. The dynamic data may indicate the currently installed position of the child safety seat in the vehicle. The baseline data and dynamic data may be input into a trained machine-learning model.

In response to the inputting, the machine-learning model may determine whether the child safety seat is installed in the optimized position in the vehicle. For example, the machine-learning model may determine that the child safety seat is not installed in the optimized position for the make and model of the vehicle and model of the child safety seat. In response to determining that the child safety seat is not installed in the optimized position, the machine-learning model may determine a recommended adjustment for the child safety seat, in order for the child safety seat to be positioned in the optimized position. The machine-learning model may have been previously trained using training data that includes one or more vehicle makes and/or models, one or more child safety seat models, and one or more recommended adjustments to learn one or more associations between the training data.

In various embodiments, the computer-implemented method 400 may include receiving, by the one or more processors, from the machine-learning model (e.g., a machine-learning model of external system(s) 110), an indication that the ambient temperature is above a threshold, wherein the indication includes a recommended thermoset adjustment of the vehicle. A mobile device (e.g., mobile device 105) and/or a server system (e.g., server system 115A) may transmit the baseline data and/or dynamic data stored in a memory (e.g., memory 105C, memory 115E, and/or database 115A) to one or more machine-learning models for the analysis. For example, the machine-learning model may determine that the ambient temperature may be 5 degrees above a threshold maximum temperature for the child in the child safety seat based upon the baseline data and dynamic data. The resulting indication may include an alert indicating that the current ambient temperature, the ambient temperature amount above the threshold, and/or a recommendation to adjust the temperature of the vehicle environment system. In various embodiments, the recommendation may include on or more of: raising or lowering the temperature controls, increasing or decreasing the circulation system, and/or adjusting vehicle seat heating or cooling settings.

The computer-implemented method 400 may include, in response to the inputting, receiving by the one or more processors (e.g., processor 105B, processor 115D), a recommended adjustment from the machine-learning model 408. For example, the one or more processors may receive data from a machine-learning model (e.g., external systems(s) 110) indicating that the child safety seat may not be installed in the optimized position for the make and model of the vehicle and model of the child safety seat.

In various embodiments, the one or more processors (e.g., processor 105B, processor 115D) and/or machine-learning model (e.g., external system(s) 110) may analyze the expiration data to determine that the child safety seat data exceeds an expiration threshold. In response to determining the child safety seat data exceeds the expiration threshold, the one or more processors may receive a replacement child safety seat recommendation from the machine-learning model. For example, the one or more processors may analyze the stored expiration data of the child safety seat data and determine that the child safety seat has expired. The one or more processors may transmit the baseline data and/or dynamic data to one or more machine-learning models and then receive a recommended replacement child safety seat based upon the current data related to the child and vehicle.

The computer-implemented method 400 may include generating, by the one or more processors, an alert including the recommended adjustment 410. Based upon the received recommendation from the machine-learning model, one or more processors (e.g., processors 105B, processor 115D) may generate an alert that includes the adjustment recommendation. For example, the machine-learning model may provide a recommendation that one or more buckles of the child safety seat is not properly fastened, based upon the analyzed baseline data and/or dynamic data. The one or more processors may generate an alert for display on a user interface (e.g., display/UI 105A) including the recommendation to check the buckles of the child safety seat.

The computer-implemented method 400 may include outputting, by the one or more processors, the alert via a user interface of a mobile device 412. The alert may be displayed via a user interface of the mobile device. In various embodiments, the alert may be output to one or more mobile device(s). For example, the alert may be output to both a smartphone of a user and the vehicle computing system.

In various embodiments, the computer-implemented method 400 may include generating, by the one or more processors, an optimized position for the child safety seat within the vehicle based upon the occupied seat data. For example, the optimized position may be generated and/or updated in response to the occupied seat data indicating that there are other child safety seats in the vehicle. The method may further include updating, by the one or more processors, the alert based upon the optimized position for the safety seat.

In various embodiments, the computer-implemented method 400 may include receiving, by the one or more processors, accident data from the vehicle; and, in response to receiving the accident data, determining, by the one or more processors, child safety seat condition data. The machine-learning model may analyze the accident data along with other baseline data and dynamic data (e.g., child safety seat data) and generate a recommendation that includes the condition of the child safety seat. For example, the child safety seat condition data may include at least one of: a low condition, a moderate condition, and/or a high condition. The low condition may indicate that the child safety seat may not be adequate for use, the moderate condition may indicate that the child safety seat may be adequate for use, and the high condition may indicate that the child safety seat may be optimal for use.

In various embodiments, the computer-implemented method 400 may include analyzing, by the one or more processors, via a machine-learning model, the child safety seat condition data to determine that the child safety seat has a low condition. In response to determining that the child safety seat has a low condition, the method 400 may include receiving, by the one or more processors, a recommended replacement child safety seat from the machine-learning model. In various embodiments, the method 400 may then include outputting, by the one or more processors, an updated alert via the user interface of the mobile device. For example, the updated alert may include the low condition and the recommended replacement child safety seat.

Although FIG. 4 shows example blocks of exemplary method 400, in some implementations, the exemplary computer-implemented method 400 may include additional blocks, fewer blocks, different blocks, or differently arranged blocks than those depicted in FIG. 4. Additionally, or alternatively, two or more of the blocks of the exemplary computer-implemented method 400 may be performed in parallel.

### EXEMPLARY COMPUTER-BASED METHOD FOR ANALYZING A CHILD SAFETY SEAT BASED UPON ACCIDENT DATA

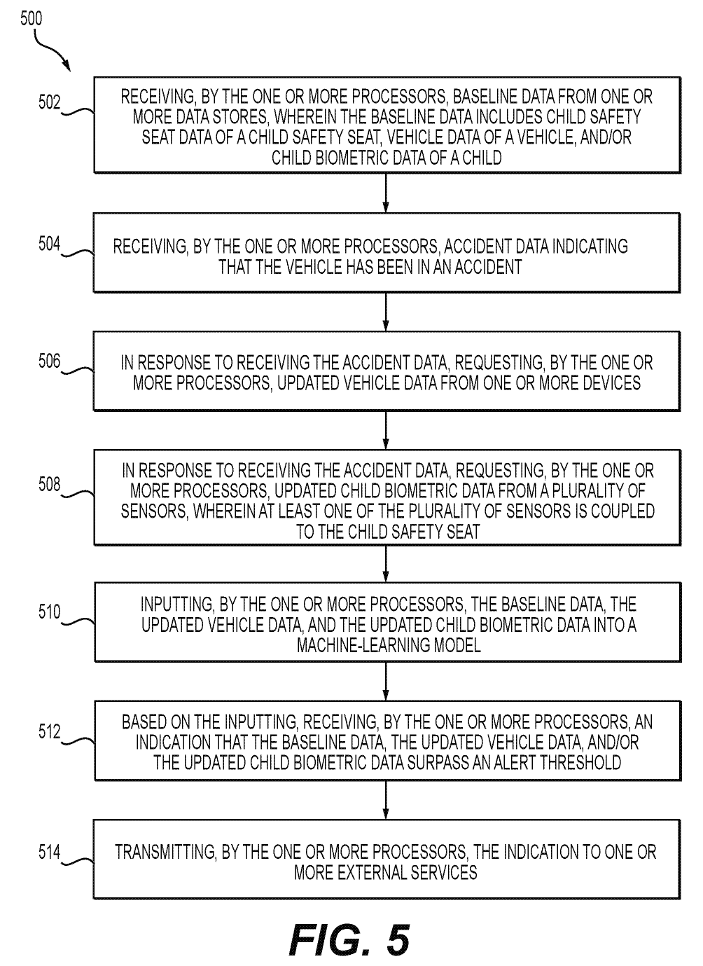

FIG. 5 depicts a flowchart of an exemplary computer-implemented method 500 for analyzing a child safety seat based upon accident data, according to one or more embodiments. Method 500 may be performed by one or more processors of a server that is in communication with one or more user devices and other external system(s) via a network. However, it should be noted that method 500 may be performed by any one or more of the server, one or more user devices, or other external systems.

The computer-implemented method 500 may include receiving, by the one or more processors (e.g., processor 105B, processor 115D), baseline data from one or more data stores (e.g., memory 105C, database 115A), wherein the baseline data includes child safety seat data, vehicle data of a vehicle, and/or child biometric data of a child 502. For example, the data stores may receive the baseline data from one or more mobile devices (e.g., cell phones, vehicle systems, etc.). The child safety seat data may include expiration data, brand data, position data, and/or dimension data. The expiration data may correspond to an expiration date of the child safety seat. The brand data may correspond to a make and/or model of the child safety seat.

Furthermore, the position data may correspond to one or more positions of the child safety seat, which may be determined via one or more sensors that are attached to the child safety seat. The dimension data may correspond to one or more dimensions of the child safety seat, such as the length, width, and/or height of the child safety seat. The child biometric data may comprise child position data, child length data, and/or child weight data. Additionally, the child biometric data may be input into a mobile device, retrieved from one or more child records (e.g., child medical records), and/or determined by one or more sensors (e.g., sensors attached to the child safety seat). The vehicle data may comprise vehicle date data, vehicle make data, and/or vehicle model data.

The computer-implemented method 500 may include accessing a computer system of a vehicle to retrieve some or all of the vehicle data. A user may input some or all of the baseline data into a mobile device (e.g., mobile device 105) via a user interface of the mobile device.

The computer-implemented method 500 may include receiving by the one or more processors, accident data indicating that the vehicle has been in an accident 504. The one or more processors may receive data from the sensors of child safety seat, mobile device(s), and/or vehicle computing system that indicate the vehicle has been in an accident. For example, the child safety seat sensors may send an indicator to the server system that the child safety seat experienced a sudden impact. The mobile device may receive an alert from emergency services that the vehicle was in an accident. The vehicle computing system may send an indicator to the server system that there was an engine failure, the vehicle had a sudden impact, the vehicle came to a sudden stop, and the like.

The computer-implemented method 500 may include, in response to receiving the accident data, requesting, by the one or more processors, updated vehicle data from one or more devices 506. For example, the one or more processors may request updated data, or continuous data (e.g., real-time) from a mobile device (e.g., mobile device(s) 105), such as any the vehicle computing system, smartphone, tablet, or other device. The vehicle computing system may collect system and diagnostic data indicating the status of the vehicle, imaging (e.g., camera, radio detection and ranging (RADAR), light detection and ranging (LiDAR), etc.), location, and/or other data relevant to the status of the vehicle. Additionally, mobile devices, such as smartphones, may collect similarly relevant data.

The computer-implemented method 500 may further include, in response to receiving the accident data, requesting, by the one or more processors, updated child biometric data from a plurality of sensors, wherein at least one of the plurality of sensors is coupled to the child safety seat 508. The one or more processors may receive updated dynamic data corresponding to the current condition of the child and/or child safety seat. For example, the updated child biometric data may include position data, weight data, length data, heart rate, respiratory rate, and/or other biometric data collected by the plurality of sensors coupled to child safety seat and/or located in the vehicle.

The computer-implemented method 500 may include inputting, by the one or more processors, the baseline data, the updated vehicle data, and the updated child biometric data into a machine-learning model 510. The machine-learning model may have been previously trained using training data that includes baseline data, updated vehicle data, and/or updated child biometric data, and one or more accident outcomes where the machine-learning model may have been trained to learn one or more associations between the training data. For example, the machine-learning model may learn associations to determine the severity of an accident and the potential impact to the child.

The computer-implemented method 500 may include, based upon the inputting, receiving by the one or more processors, an indication that the baseline data, the updated vehicle data, and the updated child biometric data surpass an alert threshold. For example, the machine-learning model may include one or more machine-learning models trained to determine the impact of the accident on the child (e.g., when a child is in distress), the severity of the accident, and/or a combination of both.

The machine-learning model, based upon the updated child biometric data and/or the baseline child biometric data, may determine whether the child needs medical assistance and/or evaluation. The machine-learning model may also analyze the updated vehicle data and/or accident data to determine whether accident surpasses a severity threshold. For example, the use of automatic breaking in the vehicle may trigger the accident data, where the machine-learning model may analyze the updated vehicle data to determine that a severe accident occurred and that emergency services should be contacted.

The computer-implemented method 500 may include, transmitting, by the one or more processors, the indication to one or more external services 514. For example, the mobile device, the server system, and/or the external system(s) may contact emergency services (e.g., medical services, law enforcement, fire department, etc.) with the indication that an accident has occurred. The indication may include additional data or information to assist the contacted external services. For example, the indication may further include a location of the child safety seat in the vehicle, e.g., a seat location, side of the vehicle, row of seats, etc. The indication may also include the updated vehicle data, updated child biometric data, and/or updated child safety seat data.

In various embodiments, the computer-implemented method 500 may include, in response to receiving the accident data, determining by the one or more processors, child safety seat condition data. For example, the child safety seat condition data may include at least one of: a low condition, a moderate condition, and/or a high condition. The low condition indicates that the child safety seat is not adequate for use, the moderate condition indicates that the child safety seat is adequate for use, and the high condition indicates that the child safety seat is optimal for use. The one or more processors may transmit the data to one or more machine-learning models to determine the condition of the child safety seat.

In certain embodiments, this process may occur in conjunction with the analysis of accident data. The condition of the child safety seat may be a factor in determining the baseline data, the updated vehicle data, and the updated child biometric data surpass an alert threshold. The condition of the child safety seat may also or alternatively be assessed after Block 512, to provide an indication whether the child safety seat should be replaced after an accident occurs.

In various embodiments, the computer-implemented method 500 may include analyzing, by the one or more processors, via a machine-learning model, the child safety seat condition data to determine that the child safety seat has a low condition. In response to in response to determining that the child safety seat has a low condition, the method 500 may include receiving, by the one or more processors, a recommended replacement child safety seat from the machine-learning model. In various embodiments, the method 500 may then include outputting, by the one or more processors, an updated alert via the user interface of the mobile device. For example, the updated alert may include the low condition and the recommended replacement child safety seat.

Although FIG. 5 shows example blocks of exemplary computer-implemented method 500, in some implementations, the exemplary method 500 may include additional blocks, fewer blocks, different blocks, or differently arranged blocks than those depicted in FIG. 5. Additionally, or alternatively, two or more of the blocks of the exemplary computer-implemented method 500 may be performed in parallel.

### EXEMPLARY COMPUTER-BASED METHOD FOR SELECTING SAFETY SEAT

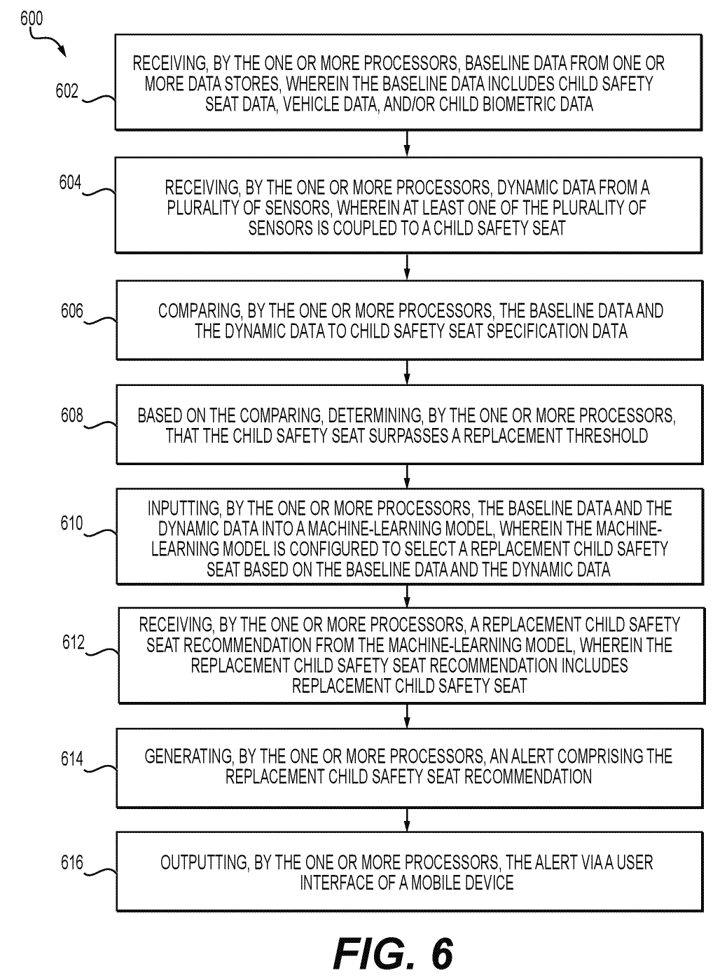

FIG. 6 depicts a flowchart of an exemplary computer-implemented method 600 for selecting a child safety seat based upon baseline data and dynamic data, according to one or more embodiments. Method 600 may be performed by one or more processors of a server that is in communication with one or more user devices and other external system(s) via a network. However, it should be noted that method 600 may be performed by any one or more of the server, one or more user devices, or other external systems.

The computer-implemented method 600 may include receiving, by the one or more processors (e.g., processor 105B, processor 115D), baseline data from one or more data stores (e.g. memory, 105C, memory 115E, database(s) 115A), wherein the baseline data include child safety seat data, vehicle data, and/or child biometric data 602. For example, the data stores may receive the baseline data from one or more mobile devices (e.g., cell phones, vehicle systems, etc.). The child safety seat data may include expiration data, brand data, position data, and/or dimension data. The expiration data may correspond to an expiration date of the child safety seat. The brand data may correspond to a make and/or model of the child safety seat.

Furthermore, the position data may correspond to one or more positions of the child safety seat, which may be determined via one or more sensors that are attached to the child safety seat. The dimension data may correspond to one or more dimensions of the child safety seat, such as the length, width, and/or height of the child safety seat. The child biometric data may comprise child position data, child length data, and/or child weight data.

The child biometric data may be input into a mobile device, retrieved from one or more child records (e.g., child medical records), and/or determined by one or more sensors (e.g., sensors attached to the child safety seat). The vehicle data may comprise vehicle date data, vehicle make data, and/or vehicle model data. The method 600 may include accessing a computer system of a vehicle to retrieve some or all of the vehicle data. A user may input some or all of the baseline data into a mobile device (e.g., mobile device 105) via a user interface of the mobile device.

The computer-implemented method 600 may include receiving, by the one or more processors, dynamic data from a plurality of sensors, wherein at least one of the plurality of sensors is coupled to a child safety seat 404. For example, the received dynamic data may comprise ambient temperature data at the child safety seat position. The received dynamic data may include occupied seat data, wherein the occupied seat data may include one or more corresponding occupied seat locations. In various embodiments, the vehicle may include one or more sensors that are configured to determine whether a seat is occupied, the location of the occupied seat, and/or data regarding the user(s) who are occupying a seat.

Additionally or alternatively, the dynamic data may include current child biometric data in relation to the position of the child in the child safety seat. For example, the biometric data may include child position data, child length data, and/or child weight data. In various embodiments, the dynamic data may include child biometric data corresponding to respiratory rate data, heart rate data, and/or biometric data actively monitored by the sensors coupled to the child safety seat, as described with reference to FIG. 2.

In various embodiments, the computer-implemented method 600 may include collecting, by the one or more processors, the dynamic data in real-time from the plurality of sensors and storing, by the one or more processors, the baseline data and the dynamic data collected in real-time in the one or more data stores. Over time, the baseline data may be updated based upon the dynamic data. For example, as the child grows the baseline data may be updated to a new baseline for each of the collected child biometric data points. In various embodiments, the baseline data may be updated when the child safety seat is replaced with the replacement child safety seat.

The computer-implemented method 600 may include comparing, by the one or more processors, the baseline data and the dynamic data to child safety seat specification data 606. The one or more processors may access the child safety seat specification data via a network (e.g., network 101) and external system(s) 110 or data stores (e.g., memory 105C, memory 115E, database(s) 115A). The comparing may include comparing the height, weight, age, etc. thresholds identified by the child safety seat specification data and dynamic data and/or baseline data. For example, the baseline data may indicate that the child meets the threshold (e.g., a height threshold, a weight threshold, and/or an age threshold) identified by the child safety seat data. The dynamic data may indicate that the child has outgrown the child safety seat by comparing the real-time collection of child biometric data to the baseline data.

In various embodiments, the computer-implemented method 600 may include analyzing, by the one or more processors, the stored baseline data and the stored dynamic data; and, based upon the analyzing, predicting, by the one or more processors, time data corresponding to when the child biometric data will exceed a threshold of the child safety seat specification data. The one or more processors may input the baseline data and dynamic data into a machine-learning model to predict a timeframe for when the dynamic data of the child may exceed one or more thresholds of the child safety seat specification data. For example, based upon the change in baseline and dynamic data over a six month time period, a machine-learning model may predict that the dynamic data corresponding to the child biometric data may exceed one or more thresholds of the child safety seat specification in three to six months. This may prompt a periodic alert and/or reminder to mobile device(s) 105 regarding an expected time frame for the child to exceed the threshold of the child safety seat.

The computer-implemented method 600 may include, based upon the comparing, determining by the one or more processors, that the child safety seat surpasses a replacement threshold 608. For example, when one or more baseline data and/or dynamic data exceeds the one or more thresholds of the child safety seat specification data, the one or more processors may determine that the child safety seat should be replaced.

In various embodiments, one or more processors may determine the child safety seat surpasses the replacement threshold via a machine-learning model trained to determine a replacement threshold based upon the child safety seat specification data. For example, the machine-learning model may determine that the child safety seat surpasses a replacement threshold before the child biometric data actually exceeds one or more thresholds of the child safety seat specification data. This may allow time for a replacement child safety seat to be obtained while the baseline data and/or dynamic data indicates that the child may be still within the child safety seat specification data thresholds.

In various embodiments, in response to determining that the child safety seat surpasses a replacement threshold, the baseline data corresponding to the child biometric data may be updated with the current dynamic data corresponding to the child biometric data. In Block 610, the updated child biometric data may be used by the machine-learning model to determine a recommended replacement child safety seat that matches the current child biometric data for the child.

The computer-implemented method 600 may include inputting, by the one or more processors, the baseline data and the dynamic data into a machine-learning model (e.g., external system(s) 110), wherein the machine-learning model is configured to select a replacement child safety seat based upon the baseline data and the dynamic data 610. The machine-learning model may compare the baseline data and child safety seat data with available child safety seats to determine the optimal replacement child safety seat. For example, the method 600 may include requesting and receiving available child safety seat data from one or more external systems, where the available child safety seat data may be input into the machine-learning model. The optimal replacement child safety seat may be based upon a combination of the child biometric data, vehicle data, and current child safety seat data.

The machine-learning model may also recommend a change in the type of child safety seat. For example, recommended adjustments may include a recommendation to move from a rear-facing child safety seat to a front facing child safety seat, a recommendation to move from a front facing child safety seat to a booster seat, and/or a recommendation to move from a booster seat to sitting in the vehicle seat normally, without the aid of a child safety seat or booster seat.

The computer-implemented method 600 may include receiving, by the one or more processors, a replacement child safety seat recommendation from the machine-learning model, wherein the replacement child safety seat recommendation includes replacement child safety seat model data 612. For example, the one or more processors may receive a brand, model and/or serial number, a link to purchase the replacement child safety seat, or other data to identify the replacement child safety seat. The one or more processors may receive updated child safety seat specification data. The updated child safety seat specification data may be used for comparisons and predictions in repetitions of Blocks 602 through 610.

The method 600 may include generating, by the one or more processors, an alert comprising the replacement child safety seat recommendation 614. Based upon the received recommendation from the machine-learning model, one or more processors (e.g., processors 105B, processor 115D) may generate an alert providing the recommendation for the replacement child safety seat. The alert may also include a time frame for replacing the child safety seat. For example, the machine-learning model may provide a recommended replacement child safety seat, as well as recommend that the replacement should be made within a month.

The machine-learning model may determine the time frame based upon the change in baseline data and dynamic data corresponding to the child biometric data, as described above. For example, the one or more processors may generate an alert for display on a user interface (e.g., display/UI 105A) that includes a recommendation to check the buckles of the child safety seat.

The computer-implemented method 600 may include outputting, by the one or more processors, the alert via a user interface of a mobile device (e.g., display/UI 105A, display/UI 115C) 616. The alert may be displayed via the user interface. In various embodiments, the alert may be output to one or more mobile device(s) 105. For example, the alert may be output to both a smartphone of a user and the vehicle computing system.

In certain embodiments, the computer-implemented method 600 may further include inputting, by the one or more processors, the occupied seat data, the baseline data, and the dynamic data into the machine-learning model and receiving an updated replacement child safety seat recommendation from the machine-learning model. The one or more processors may output the updated replacement child safety seat recommendation to user interface of the mobile device. For example, the dynamic data collected over a period of time may indicate that the seat next to the child safety seat is occupied a majority of the time by another person or child, child safety seat, booster seat, etc. In response, the machine-learning model may determine a child safety seat that may improve the safety for the child in the child safety seat and/or occupied seats.

Although FIG. 6 shows example blocks of exemplary computer-implemented method 600, in some implementations, the exemplary method 600 may include additional blocks, fewer blocks, different blocks, or differently arranged blocks than those depicted in FIG. 6. Additionally, or alternatively, two or more of the blocks of the exemplary computer-implemented method 500 may be performed in parallel.

### EXEMPLARY COMPUTING DEVICE

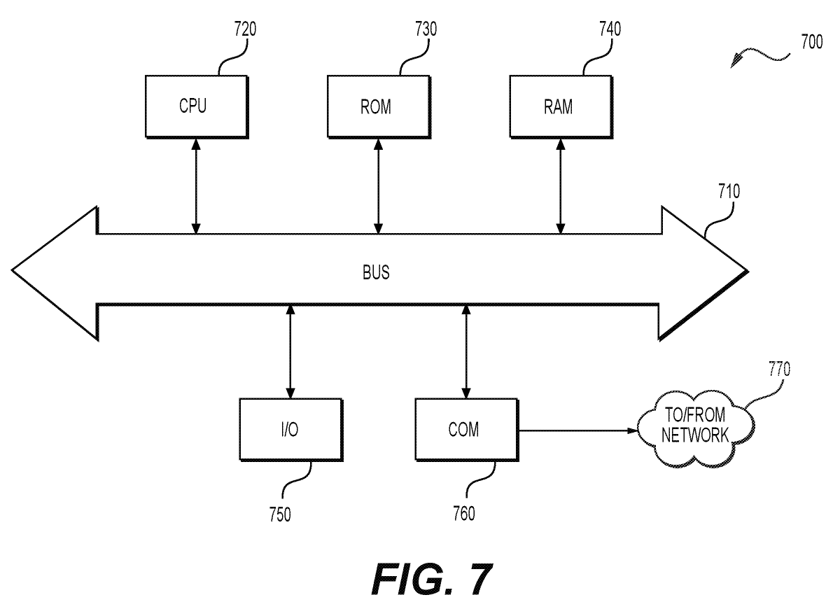

FIG. 7 is a simplified functional block diagram of an exemplary computer or computing device 700 that may be configured as a device for executing the methods of FIGS. 4–6, according to exemplary embodiments of the present disclosure. For example, device 105 may include a central processing unit (CPU) 720. CPU 720 may be any type of processor device including, for example, any type of special purpose or a general-purpose microprocessor device. As will be appreciated by persons skilled in the relevant art, CPU 720 also may be a single processor in a multi-core/multiprocessor system, such system operating alone, or in a cluster of computing devices operating in a cluster or server farm. CPU 720 may be connected to a data communication infrastructure 710, for example, a bus, message queue, network, or multi-core message-passing scheme.

Device 700 also may include a main memory 740, for example, random access memory (RAM), and also may include a secondary memory 730. Secondary memory 730, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 730 may include other similar means for allowing computer programs or other instructions to be loaded into device 300. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 700.

Device 700 also may include a communications interface (“COM”) 760. Communications interface 360 allows software and data to be transferred between device 300 and external devices. Communications interface 760 may include a modem, a network interface (such as an Ethernet card), a communications port, a PCMCIA slot and card, or the like. Software and data transferred via communications interface 360 may be in the form of signals, which may be electronic, electromagnetic, optical, or other signals capable of being received by communications interface 760. These signals may be provided to communications interface 760 via a communications path of device 700, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 700 also may include input and output ports 750 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming.

All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as those used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the general description and the detailed description are exemplary and explanatory only and are not restrictive of the features, as claimed.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while various embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Blocks may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

### EXEMPLARY COMPUTER-BASED EMBODIMENTS

A computer-implemented method for analyzing child safety seat position data in a vehicle may be provided. The computer-implemented method may be performed by one or more processors of a computing system in communication with one or more data sources. The computer-implemented method may include (1) receiving, by the one or more processors, baseline data from one or more data stores, wherein the baseline data includes child safety seat data, vehicle data, and/or child biometric data; (2) receiving, by the one or more processors, dynamic data from a plurality of sensors, wherein at least one of the plurality of sensors is coupled to a child safety seat; (3) inputting, by the one or more processors, the baseline data and the dynamic data into a machine-learning model, wherein the machine-learning model is configured to determine a recommended adjustment for the child safety seat; (4) determining, by the one or more processors, a completion of the one or more recommended actions; (5) in response to the inputting, receiving, by the one or more processors, a recommended adjustment from the machine-learning model; (6) generating, by the one or more processors, an alert including the recommended adjustment; and/or (7) outputting, by the one or more processors, the alert via a user interface of a mobile device. The method may include additional, less, or alternate functionality, including that discussed elsewhere herein.

For instance, generating, by the one or more processors, an alert including the recommended adjustment may include (i) receiving, by the one or more processors, baseline data and dynamic data regarding the position of the child within the child safety seat; and/or (ii) receiving, by the one or more processors, a recommended adjustment for the child and/or child safety seat according to the baseline data and the dynamic data.

In various embodiments, the voice bots or chatbots may be configured to utilize AI and/or ML techniques, such as for input or output devices. For instance, a voice bot or chatbot may be a ChatGPT chatbot, an InstructGPT bot, a Codex bot, or a Google Bard bot. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT, InstructGPT bot, Codex bot, or Google Bard bot.

A computer-implemented method for analyzing child safety seat data based upon accident data may be provided. The computer-implemented method may be performed by one or more processors of a computing system in communication with one or more data sources. The computer-implemented method may include (1) receiving, by the one or more processors, baseline data from one or more data stores, wherein the baseline data includes child safety seat data of a child safety seat, vehicle data of a vehicle, and/or child biometric data of a child; (2) receiving, by the one or more processors, accident data indicating that the vehicle has been in an accident; (3) in response to receiving the accident data, requesting, by the one or more processors, updated vehicle data from one or more devices; (4) in response to receiving the accident data, requesting, by the one or more processors, updated child biometric data from a plurality of sensors, wherein at least one of the plurality of sensors is coupled to the child safety seat; (5) inputting, by the one or more processors, the baseline data, the updated vehicle data, and the updated child biometric data into a machine-learning model; (6) based upon the inputting, receiving, by the one or more processors, an indication that the baseline data, the updated vehicle data, and/or the updated child biometric data surpass an alert threshold; and/or (7) transmitting, by the one or more processors, the indication to one or more external services. The method may include additional, less, or alternate functionality, including that discussed elsewhere herein.

For instance, transmitting, by the one or more processors, the indication to one or more external services may include (i) receiving, by the one or more processors, baseline data, updated vehicle data, updated child biometric data and/or accident data that may indicate an accident has occurred and emergency services should be contacted and/or (ii) receiving, by the one or more processors, a the indication that the baseline data, updated vehicle data, and/or updated child biometric data exceed a threshold and emergency services should be contacted.

A computer-implemented method for selecting a child safety seat may be provided. The computer-implemented method may be performed by one or more processors of a computing system in communication with one or more data sources. The computer-implemented method may include (1) receiving, by the one or more processors, baseline data from one or more data stores, wherein the baseline data includes child safety seat data, vehicle data, and/or child biometric data; (2) receiving, by the one or more processors, dynamic data from a plurality of sensors, wherein at least one of the plurality of sensors is coupled to a child safety seat; (3) comparing, by the one or more processors, the baseline data and the dynamic data to child safety seat specification data; (4) based upon the comparing, determining, by the one or more processors, that the child safety seat surpasses a replacement threshold; (5) inputting, by the one or more processors, the baseline data and the dynamic data into a machine-learning model, wherein the machine-learning model is configured to select a replacement child safety seat based upon the baseline data and the dynamic data; (6) receiving, by the one or more processors, a replacement child safety seat recommendation from the machine-learning model, wherein the replacement child safety seat recommendation includes replacement child safety seat model data; (7) generating, by the one or more processors, an alert comprising the replacement child safety seat recommendation; and/or (8) outputting, by the one or more processors, the alert via a user interface of a mobile device. The method may include additional, less, or alternate functionality, including that discussed elsewhere herein.

For instance, generating, by the one or more processors, an alert comprising the replacement child safety seat recommendation may include (i) receiving, by the one or more processors, baseline data and/or dynamic data corresponding to the child, child safety seat, and/or vehicle, and/or (ii) receiving, by the one or more processors, a recommended child safety seat based upon the received baseline data and dynamic data.

### ADDITIONAL CONSIDERATIONS

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the actions, operations, and/or functionality of computer-implemented methods discussed are performed in one embodiment by an appropriate processor (or processors) of a processing (i.e.,computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘_______’ is hereby defined to mean…” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Finally, unless a claim element is defined by expressly reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Various embodiments may be described using the expression “coupled” and “connected” along with their derivatives. For example, various embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The terminology used herein may be interpreted in its broadest reasonable manner, even though it is being used in conjunction with a detailed description of certain specific examples of the present disclosure. Indeed, certain terms may even be emphasized; however, any terminology intended to be interpreted in any restricted manner will be overtly and specifically defined as such in this Detailed Description section. Both the foregoing general description and the detailed description are exemplary and explanatory only and are not restrictive of the features, as claimed.

In the detailed description herein, references to “embodiment,” “an embodiment,” “one non-limiting embodiment,” “in various embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In general, terminology can be understood at least in part from usage in context. For example, terms, such as “and”, “or”, or “and/or,” as used herein can include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, can be used to describe any feature, structure, or characteristic in a singular sense or can be used to describe combinations of features, structures or characteristics in a plural sense. Similarly, terms, such as “a,” “an,” or “the,” again, can be understood to convey a singular usage or to convey a plural usage, depending at least in part upon context. In addition, the term “based upon” can be understood as not necessarily intended to convey an exclusive set of factors and can, instead, allow for the existence of additional factors not necessarily expressly described, again, depending at least in part on context.

As used herein, a “model” or “machine-learning model” generally encompasses instructions, data, and/or a model configured to receive input, and apply one or more of a weight, bias, classification, or analysis on the input to generate an output (e.g., a video, a text-based output, or an audio output). The output may include, for example, a classification of the input, an analysis based upon the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. Any suitable type of training may be used, e.g., stochastic, gradient boosted, random seeded, recursive, epoch or batch-based, etc.

Certain non-limiting embodiments are described below with reference to block diagrams and operational illustrations of methods, processes, devices, and apparatus. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method for analyzing child safety seat position data in a vehicle, the computer-implemented method performed by one or more processors of a computing system in communication with one or more data sources, the computer-implemented method comprising:
receiving, by the one or more processors, baseline data from one or more data stores, wherein the baseline data includes child safety seat data, vehicle data, and/or child biometric data;
receiving, by the one or more processors, dynamic data from a plurality of sensors, wherein at least one of the plurality of sensors is coupled to a child safety seat;
inputting, by the one or more processors, the baseline data and the dynamic data into a machine-learning model, wherein the machine-learning model is configured to determine a recommended adjustment for the child safety seat;
in response to the inputting, receiving, by the one or more processors, a recommended adjustment from the machine-learning model;
generating, by the one or more processors, an alert including the recommended adjustment; and
outputting, by the one or more processors, the alert via a user interface of a mobile device.

2. The computer-implemented method of claim 1, wherein the received dynamic data comprises an ambient temperature at the child safety seat.

3. The computer-implemented method of claim 2, further comprising:
receiving, by the one or more processors, from the machine-learning model, an indication that the ambient temperature is above a threshold, wherein the indication includes a recommended thermoset adjustment of the vehicle.

4. The computer-implemented method of claim 1, wherein the received dynamic data includes occupied seat data, wherein the occupied seat data includes one or more corresponding occupied seat locations.

5. The computer-implemented method of claim 4, the method further comprising:
generating, by the one or more processors, an optimized position for the child safety seat within the vehicle based upon the occupied seat data; and
updating, by the one or more processors, the alert based upon the optimized position for the child safety seat.

6. The computer-implemented method of claim 1, wherein the child biometric data includes child position data, child length data, and/or child weight data, and wherein the vehicle data includes vehicle date data, vehicle make data, and/or vehicle model data.

7. The computer-implemented method of claim 1, wherein the child safety seat data includes expiration data, brand data, position data, and/or dimension data.

8. The computer-implemented method of claim 7, further comprising:
analyzing, by the one or more processors, the expiration data to determine that the child safety seat data exceeds an expiration threshold; and
in response to determining that the child safety seat data exceeds the expiration threshold, receiving, by the one or more processors a replacement child safety seat recommendation from the machine-learning model.

9. The computer-implemented method of claim 1, further comprising:
creating, by the one or more processors, child profile data that includes the received baseline data and the received dynamic data; and
storing the child profile data in the one or more data stores.

10. A computer-implemented method of claim 1, further comprising:
receiving, by the one or more processors, accident data from the vehicle; and
in response to receiving the accident data, determining, by the one or more processors, child safety seat condition data, wherein the child safety seat condition data includes at least one of: a low condition, a moderate condition, and/or a high condition, wherein the low condition indicates that the child safety seat is not adequate for use, the moderate condition indicates that the child safety seat is adequate for use, and the high condition indicates that the child safety seat is optimal for use.

11. The computer-implemented method of claim 10, further comprising:
analyzing, by the one or more processors, via the machine-learning model, the child safety seat condition data to determine that the child safety seat has a low condition;
in response to determining that the child safety seat has a low condition, receiving, by the one or more processors, a recommended replacement child safety seat from the machine-learning model; and
outputting, by the one or more processors, an updated alert via the user interface of the mobile device, wherein the updated alert includes the low condition and the recommended replacement child safety seat.

12. A computer-implemented method for analyzing child safety seat data based upon accident data, the computer-implemented method performed by one or more processors of a computing system in communication with one or more data sources, the computer-implemented method comprising:
receiving, by the one or more processors, baseline data from one or more data stores, wherein the baseline data includes child safety seat data of a child safety seat, vehicle data of a vehicle, and/or child biometric data of a child;
receiving, by the one or more processors, accident data indicating that the vehicle has been in an accident;
in response to receiving the accident data, requesting, by the one or more processors, updated vehicle data from one or more devices;
in response to receiving the accident data, requesting, by the one or more processors, updated child biometric data from a plurality of sensors, wherein at least one of the plurality of sensors is coupled to the child safety seat;
inputting, by the one or more processors, the baseline data, the updated vehicle data, and the updated child biometric data into a machine-learning model;
based upon the inputting, receiving, by the one or more processors, an indication that the baseline data, the updated vehicle data, and/or the updated child biometric data surpass an alert threshold; and
transmitting, by the one or more processors, the indication to one or more external services.

13. The computer-implemented method of claim 12, wherein the indication further comprises a location of the child safety seat in the vehicle.

14. The computer-implemented method of claim 12, further comprising:
in response to receiving the accident data, determining, by the one or more processors, child safety seat condition data, wherein the child safety seat condition data includes at least one of: a low condition, a moderate condition, and/or a high condition, wherein the low condition indicates that the child safety seat is not adequate for use, the moderate condition indicates that the child safety seat is adequate for use, and the high condition indicates that the child safety seat is optimal for use.

15. The computer-implemented method of claim 14, further comprising:
analyzing, by the one or more processors, via the machine-learning model, the child safety seat condition data to determine that the child safety seat has a low condition;
in response to determining that the child safety seat has a low condition, receiving, by the one or more processors, a recommended replacement child safety seat from the machine-learning model; and
outputting, by the one or more processors, an updated alert via a user interface of a mobile device, wherein the updated alert includes the low condition and the recommended replacement child safety seat.

16. A computer-implemented method for selecting a child safety seat, the computer-implemented method performed by one or more processors of a computing system in communication with one or more data sources, the computer-implemented method comprising:
receiving, by the one or more processors, baseline data from one or more data stores, wherein the baseline data includes child safety seat data, vehicle data, and/or child biometric data;
receiving, by the one or more processors, dynamic data from a plurality of sensors, wherein at least one of the plurality of sensors is coupled to a child safety seat;
comparing, by the one or more processors, the baseline data and the dynamic data to child safety seat specification data;
based upon the comparing, determining, by the one or more processors, that the child safety seat surpasses a replacement threshold;
inputting, by the one or more processors, the baseline data and the dynamic data into a machine-learning model, wherein the machine-learning model is configured to select a replacement child safety seat based upon the baseline data and the dynamic data;
receiving, by the one or more processors, a replacement child safety seat recommendation from the machine-learning model, wherein the replacement child safety seat recommendation includes replacement child safety seat model data;
generating, by the one or more processors, an alert comprising the replacement child safety seat recommendation; and
outputting, by the one or more processors, the alert via a user interface of a mobile device.

17. The computer-implemented method of claim 16, further comprising:
collecting, by the one or more processors, the dynamic data in real-time from the plurality of sensors; and
storing, by the one or more processors, the baseline data and the dynamic data collected in real-time in the one or more data stores.

18. The computer-implemented method of claim 17, further comprising:
analyzing, by the one or more processors, the stored baseline data and the stored dynamic data; and
based upon the analyzing, predicting, by the one or more processors, time data corresponding to when the child biometric data will exceed a threshold of the child safety seat specification data.

19. The computer-implemented method of claim 16, wherein the received dynamic data includes occupied seat data, wherein the occupied seat data includes one or more corresponding occupied seat locations.

20. The computer-implemented method of claim 19, wherein selecting a replacement seat further comprises:
inputting, by the one or more processors, the occupied seat data, the baseline data, and the dynamic data into the machine-learning model;
receiving, by the one or more processors, an updated replacement child safety seat recommendation from the machine-learning model; and
outputting, by the one or more processors, the updated replacement child safety seat recommendation to a display of the mobile device.
